(19) United States
(12) Patent Application Publication
(10) Pub. No.: US 2004/0183041 A1
(43) Pub. Date: Sep. 23, 2004

(54) Safety switch for a water dispenser

(76) Inventor: Fang-Zhen Zheng, Shunde City (CN)

Correspondence Address: DELLETT AND WALTERS, P. O. BOX 2786, PORTLAND, OR, 97208-2786, US

(21) Appl. No.: 10/800,919

(22) Filed: Mar. 15, 2004

(30) Foreign Application Priority Data
Mar. 21, 2003 (CN) 03 2 24448.7

(51) Int. Cl. F16K 35/00

(52) U.S. Cl. 251/101

(57) ABSTRACT

A safety switch for a water dispenser includes a knob adapted to be rotatably mounted on the pushbutton and having an extension integrally formed with the knob and an abutting plate formed on an outer periphery of the extension, and a stop adapted to be integrally formed on an inner face of the panel to correspond to and engage with the abutting plate so as to prevent the movement of the pushbutton. After the rotation of the knob to misalign the abutting plate with the stop, the pushbutton is able to be pressed to release water from the water dispenser.

### BACKGROUND OF THE INVENTION

1. Field of the Invention

The present invention relates to a safety switch, and more particularly to safety switch for a water dispenser so that an accidental touch of the safety switch will not cause water to flow out of the water dispenser, thus avoiding spillage, potential injury to users etc.

2. Description of Related Art

A conventional water dispenser usually is equipped with a distilled water flag on and a water dispensing mechanism having a pushbutton to control water flow out of the distilled water flag on. By pressing the pushbutton, the distilled water is able to flow out of the distilled water flag on and thus the user is able to enjoy the distilled water. However, when the pushbutton is accidentally touched, such as someone brushing past the dispenser, heated water flowing out of the water dispenser may cause a nuisance or even injury to the people, especially children, near the water dispenser. Therefore, to avoid such an unpleasant incident from happening, patents providing safety measurements have been introduced to the market and they do have the ability to prevent such mishap from happening. However, due to the structural complexity and excessive time consumed in assembly, cost of such safety switches is never low.

To overcome the shortcomings, the present invention tends to provide an improved safety switch to mitigate the aforementioned problems.

### SUMMARY OF THE INVENTION

The primary objective of the present invention is to provide an improved safety switch which is simple in structure and easy to be assembled.

To accomplish the foregoing objective, the safety switch of the present invention is provided with a knob rotatably mounted on a pushbutton to alternately move an abutting plate to engage/disengage with a stop formed on an inner face of a panel on which the pushbutton is movably mounted.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the safety switch of the present invention with the pushbutton removed for clarity;

FIG. 2 is a schematic front plan view showing the location of the knob relative to the pushbutton;

FIG. 3 is a schematic cross sectional view of the water dispenser;

FIG. 4 is schematic view showing the relative location between the knob and the pushbutton in a second embodiment of the present invention; and

FIG. 5 is a perspective view showing the internal structure of the water dispenser of the present invention with the pushbutton removed for clarity.

### DETAILED DESCRIPTION OF THE PREFERRED EMBODIMENT

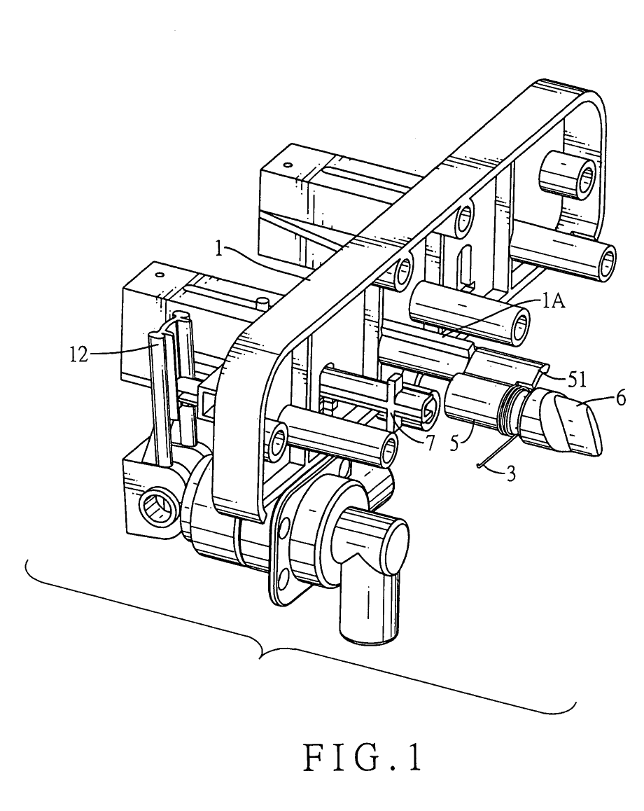

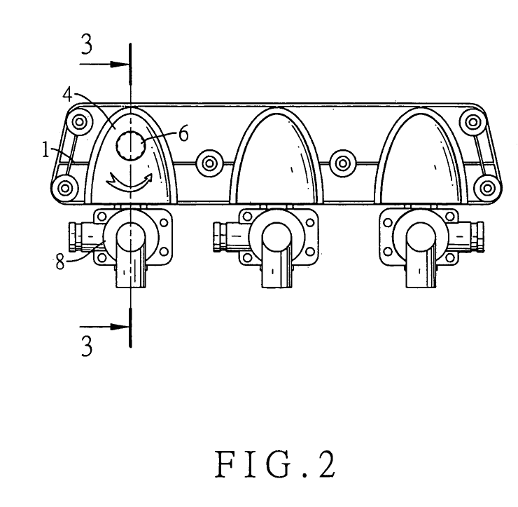

With reference to FIGS. 1 and 2, a safety switch in accordance with the present invention is adapted to combine with a water dispenser (not shown) having a pushbutton (4) movably mounted on a panel (1) for controlling water outflow from the faucet (8).

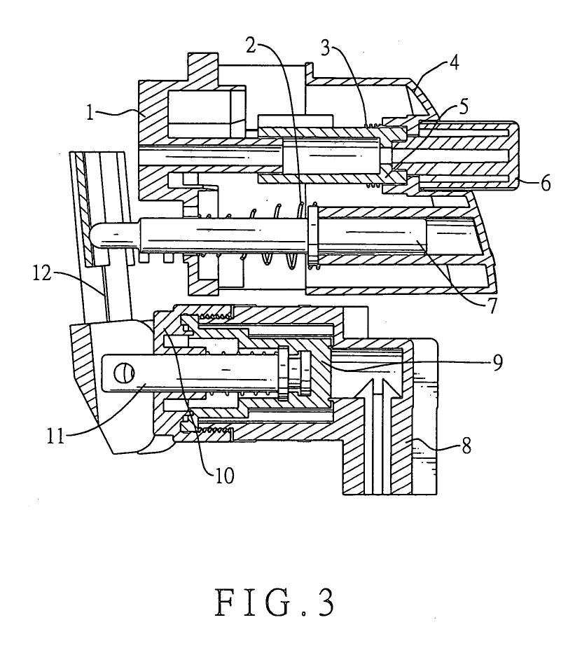

With reference to FIG. 3, it is noted that when the pushbutton (4) is pressed, a push rod (7) received in the pushbutton (4) and mounted with a spring (2) is driven to move a lever (12). After the lever (12) is moved, a guiding rod (11) is activated to move a sealing ring (9) which is received in a cover (10). Because of the retraction of the sealing ring (9) inside the cover (10), the water from the water dispenser is able to flow of the water dispenser from the faucet (8). The mechanism and structural relationship between the foregoing elements are well known in the art and detailed description thereof is thus omitted.

Referring to FIGS. 1, 2 and 3 again, it is noted that a knob (6) is rotatably mounted and extended out of the pushbutton (4). The knob (6) has an extension (5) integrally formed with the knob (6) and a torsion spring (3) mounted around the extension (5). The torsion spring (3) has a first end abutted to an outer periphery of the extension (5) and a second end abutted to an inner face of the pushbutton (4). The knob (6) further has an abutting plate (51) extending from the outer periphery of the extension (5). A stop (1A) is adapted to be formed on an inner face of the panel (1) to correspond to the abutting plate (51) of the knob (6) such that when the stop (1A) is engaged with the abutting plate (51), the pushbutton (4) is not able to be pressed downward to release water and when the stop (1A) is away from engagement with the abutting plate (51), the pushbutton (4) is able to be pressed downward to release water from the water dispenser. Again, after the knob (6) is rotated to deviate the abutting plate (51) from engagement with the stop (1A), the torsion spring (3) is able to return the knob (6) to its original position.

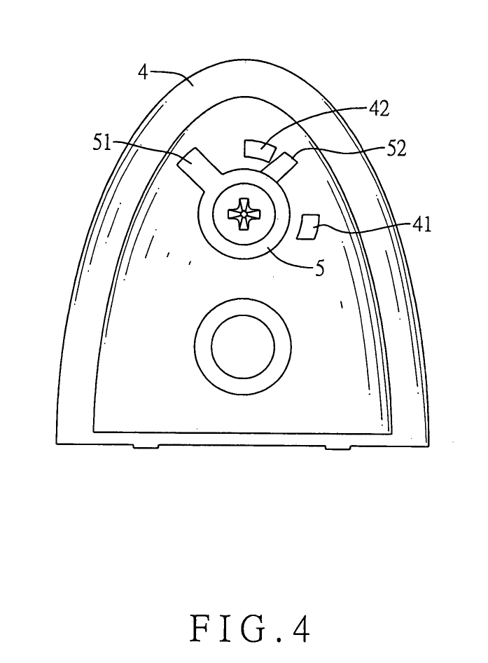

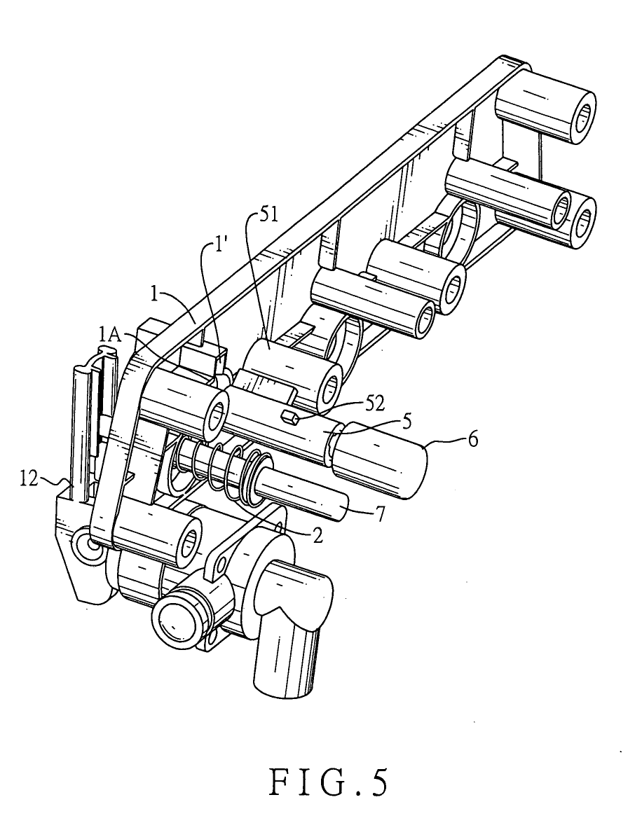

With reference to FIGS. 4 and 5, it is noted that a second embodiment of the present invention is shown. The safety switch of the present invention further has two guides (41,42) formed on an inner face of the pushbutton (4). The extension (5) has a first abutting plate (51) and a second abutting plate (52) formed on the outer periphery of the extension (5). After the knob (6) together with the extension (5) is assembled with the pushbutton (4), it is noted that the second abutting plate (52) is sandwiched between the two guides (41,42) so that excessive rotation of the knob (6) relative to the knob (4) is prevented. After the knob (6) is rotated, the first abutting plate (51) is aligned with a passage (I′) defined in the stop (1A). Thereafter, the downward movement of the pushbutton (4) allows the first abutting plate (51) to be received in the passage (1′) of the stop (1A).

From the foregoing description, it is noted that accidental touch to the pushbutton (4) will no longer activate the water outflow from the water dispenser. The user will have to rotate the knob (6) first to misalign the abutting plate (51) with the stop (1A), then the user is able to press the pushbutton (4) relative to the panel (1). Children oblivious to the danger of hot water are therefore protected from being hurt by hot water.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A safety switch for a water dispenser having a panel and a pushbutton movably mounted on the panel for controlling water flow out of the water dispenser, the safety switch comprising:
a knob adapted to be rotatably mounted on the pushbutton and having an extension integrally formed with the knob and an abutting plate formed on an outer periphery of the extension; and
a stop adapted to be integrally formed on an inner face of the panel to correspond to and engage with the abutting plate so as to prevent the movement of the pushbutton,
whereby after the rotation of the knob to misalign the abutting plate with the stop, the pushbutton is able to be pressed to release water from the water dispenser.

2. The safety switch as claimed in claim 1, wherein two guides are adapted to be formed on an inner face of the pushbutton, the extension further has a secondary abutting plate formed on the outer periphery of the extension to be sandwiched between the two guides such that excessive rotation of the knob relative to the pushbutton is avoided.

3. A safety switch for a water dispenser having a panel and a pushbutton movably mounted on the panel for controlling water flow out of the water dispenser, the safety switch comprising:
a knob adapted to be rotatably mounted on the pushbutton and having an extension integrally formed with the knob and an abutting plate formed on an outer periphery of the extension; and
a stop adapted to be integrally formed on an inner face of the panel and having a passage defined to alternately correspond to and receive therein the abutting plate so as to allow the movement of the pushbutton,
whereby after the rotation of the knob to misalign the abutting plate with the stop, the pushbutton is able to be pressed to release water from the water dispenser.
